(19) United States
(12) Patent Application Publication
(10) Pub. No.: US 2025/0070601 A1
(43) Pub. Date: Feb. 27, 2025

(54) DECOUPLABLE CHARGER PUCK WITH SUPPORT AND DESK MAT ECOSYSTEM AND METHODS OF MANUFACTURING AND USING SAME

(71) Applicant: Maisy Leigh Productions LLC, Manalapan, NJ (US)

(72) Inventors: Maisy Leigh Chung, Manalapan, NJ (US); Tristan Jerard Gabaig Ventura, Manalapan, NJ (US)

(73) Assignee: Maisy Leigh Productions LLC, Manalapan, NJ (US)

(21) Appl. No.: 18/456,256

(22) Filed: Aug. 25, 2023

(51) Int. Cl. H02J 50/70; H02J 7/00; H02J 50/10

(52) U.S. Cl. CPC H02J 50/70; H02J 7/0044; H02J 50/10

(57) ABSTRACT

A charger stand includes a support having a base and an inclined arm, the support having a first magnet on the inclined arm, and at least one second magnet disposed in the base, and a charging puck coupleable to the support, the charging puck having a body defining a recess for accepting a magnetic charger, and a third magnet disposed behind the recess within the body.

### FIELD OF THE DISCLOSURE

The present disclosure relates to devices and methods for charging mobile phones. More particularly, the present disclosure relates to charger stands having decouplable parts that can be used alone or in combination.

### BACKGROUND OF THE DISCLOSURE

Inductive charging has made significant strides in the world of mobile phones. Typical chargers utilize a series of magnets integrated into both the phone and the charging accessories, such as stand-alone chargers and mobile phone cases. When the mobile phone is brought close to the charger, the magnets align precisely, ensuring optimal charging efficiency and reliability. This technology not only simplifies the charging process but also allows users to continue using their devices while they charge, making it convenient for activities like video calls or using GPS navigation without the fuss of cables.

Conventional chargers, however, are limited in how they present or orient the mobile phone. Additionally, conventional chargers are typically only capable of being used in a single mode. It would be desirable to build on this technology to provide versatile charger stands and ecosystems that provide better functionality for the user.

### SUMMARY OF THE DISCLOSURE

In at least some examples, a charger stand includes a support having a base and an inclined arm, the support having a first magnet on the inclined arm, and at least one second magnet disposed in the base, and a charging puck coupleable to the support, the charging puck having a body defining a recess for accepting a magnetic charger, and a third magnet disposed behind the recess within the body.

### BRIEF DESCRIPTION OF THE DISCLOSURE

Various embodiments of the presently disclosed charger stands are disclosed herein with reference to the drawings, wherein:

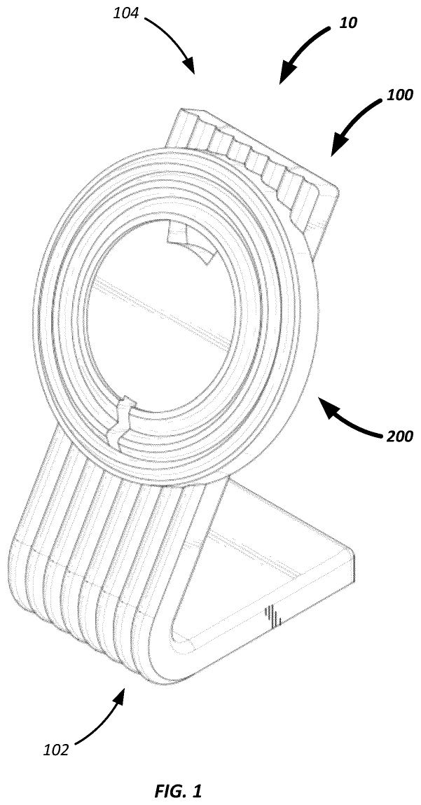

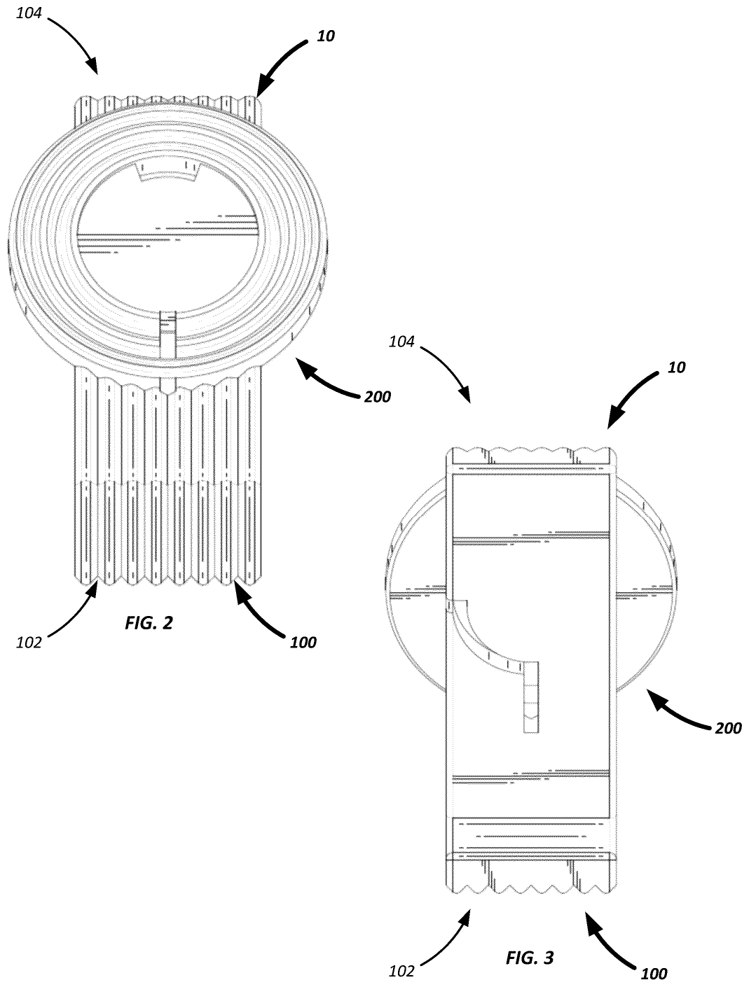

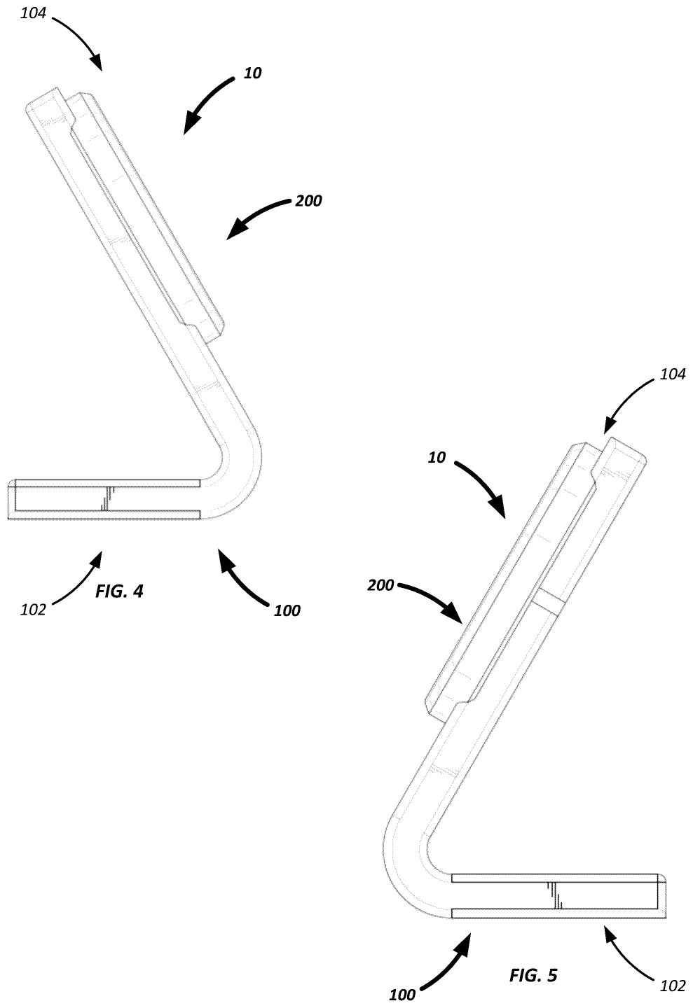

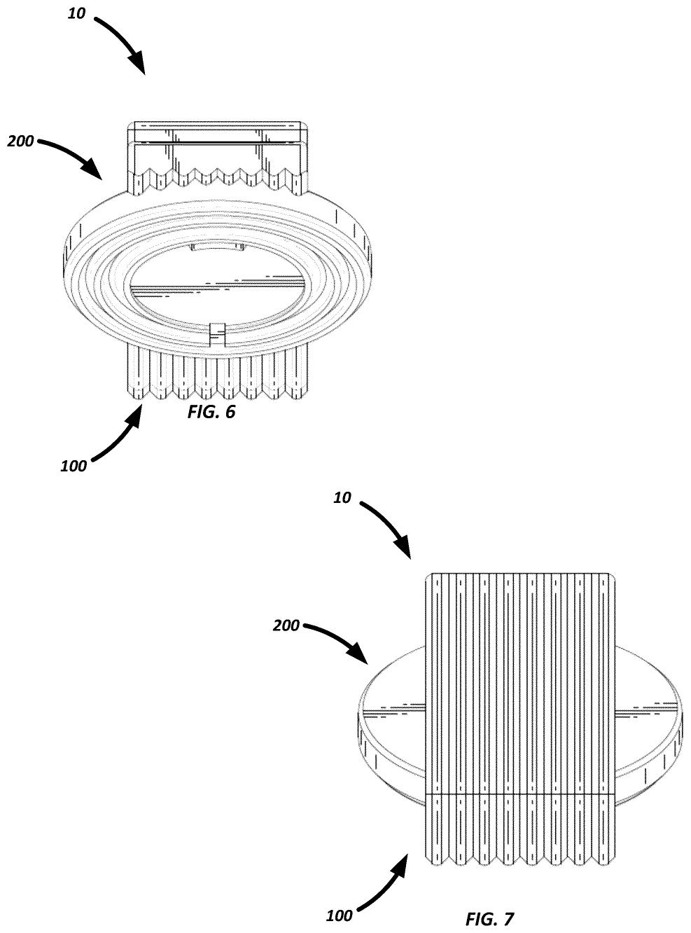

FIGS. 1-7 are schematic perspective, front, back, left, right, top plan and bottom plan views of a first embodiment of a charger stand according to one embodiment;

FIGS. 8-11 are schematic illustrations showing details of a support of a charger stand;

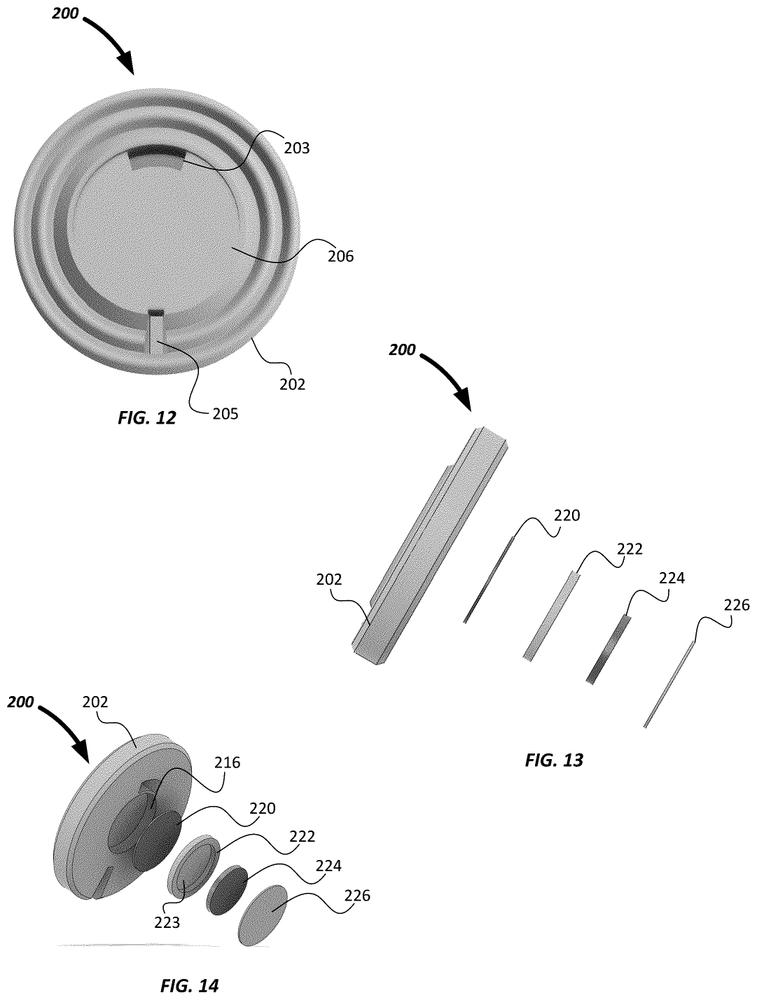

FIGS. 12-14 are schematic illustrations showing details of a charging puck of a charger stand; and

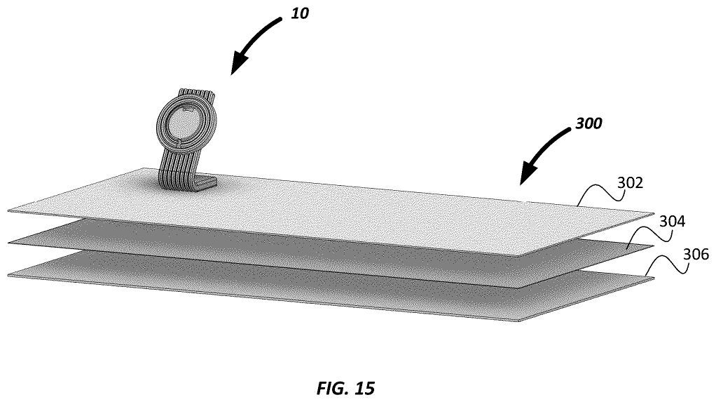

FIGS. 15-17 are schematic illustrations showing how a charger stand can be used with a magnetic desk mat.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to chargers and stands, conventional devices and methods suffer from certain shortcomings such as those discussed above.

There therefore is a need for further improvements to the devices and methods used to charge mobile phones and other electronics. Among other advantages, the present disclosure may address one or more of these needs.

FIGS. 1-7 are schematic views of a first embodiment of a charger stand 10 according to a first embodiment. Charger stand 10 generally extends between a proximal end 102 and a distal end 104, and includes a support 100 and a charging puck 200. Support 100 and charging puck 200 may be magnetically and releasably coupleable to one another as will be described in greater detail below. The details of each of support 100 and charging puck 200 will be described separately.

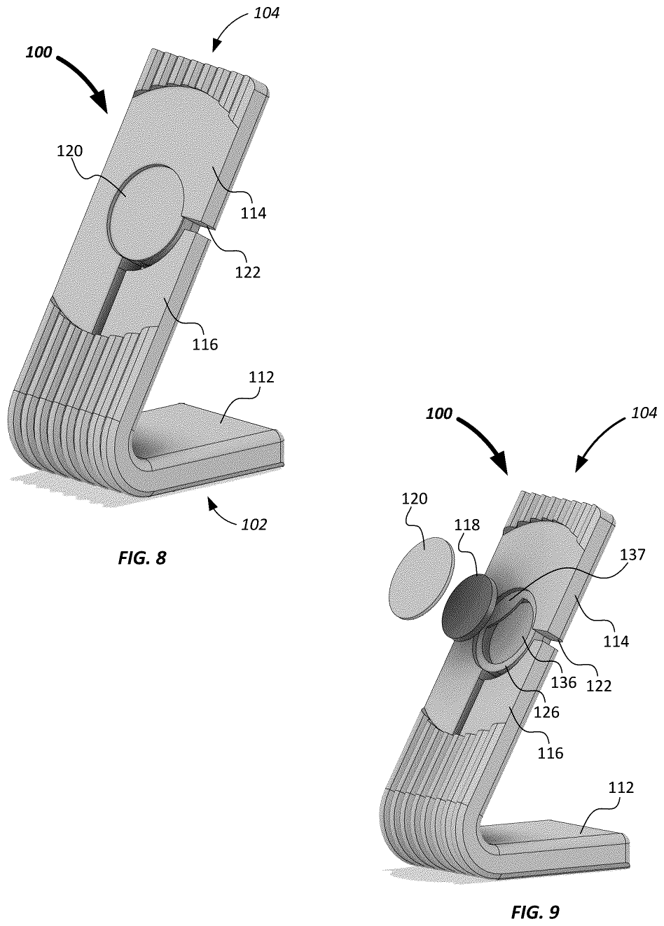

FIGS. 8-9 illustrate support 100 without charging puck 200. As shown in FIGS. 8-9, support 100 may include a flat base 112 adjacent proximal end 102 and an elongated arm 114 adjacent distal end 104. Flat base 112 and arm 114 may be unitarily formed, or may be separately formed and coupled with one another. Together, base 112 and arm 114 generally form an “L” shape, the arm 114 being angled with respect to, and forming an incline of between 45 degrees and 80 degrees with flat base 112 so that a mobile phone faces forward and upward, inclined toward the user when the charging puck 200 is coupled to support 1100.

In some examples, base 112 and arm 114 are formed of a metal, a plastic, wood or other suitable materials. Support 100 may include a generally oversized partially-circular primary recess 116, a secondary recess 126 disposed within the primary recess 116 on the front face of arm 114, and a tertiary recess 136 disposed within the secondary recess 126. In at least some examples, all three recesses 116,126,136 are concentric. Tertiary recess 136 may be generally circular and sized to accept a first magnet 118 (e.g., a 30 mm D×3 mm H neodymium magnet), but have a lip 137 to cover a sector of the magnet 118 and secure it in place. Secondary recess 126 recess may also be generally circular, and may be sized to accept a circular plastic cover 120 to secure and hide the magnet 118 when it is disposed within the third recess. A cutout 122 may extend from a side of arm 112, then form an arc around the perimeter of plastic cover 120, and then extend axially down the longitudinal axis of arm 112. The cutout 122 may be sized to allow a wire to pass therethrough so that the stand can accommodate and/or secure a wire from a charger.

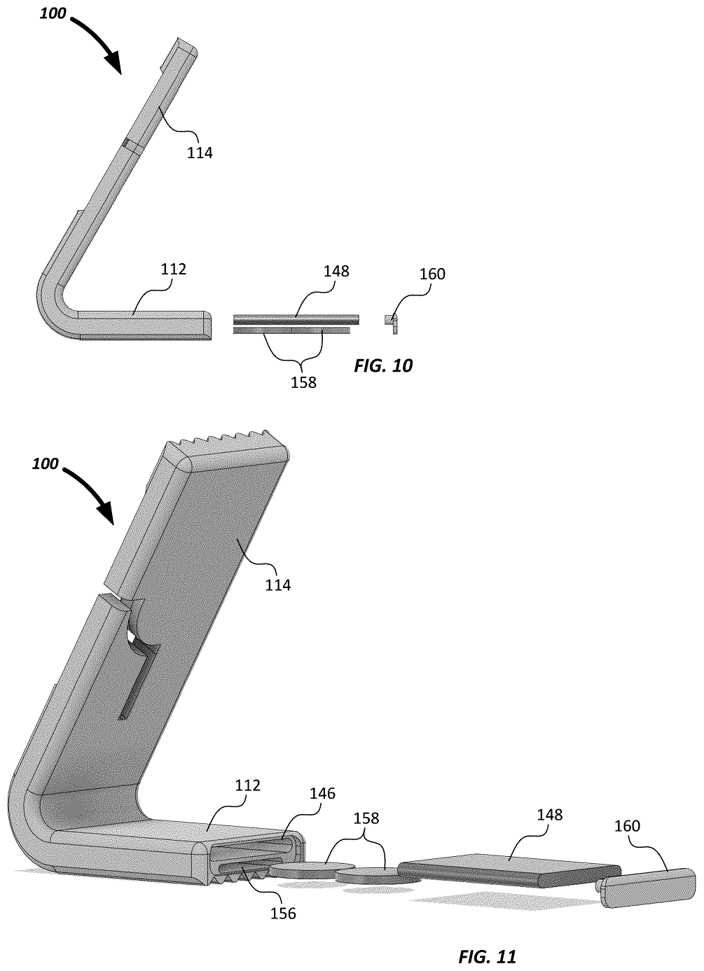

Turning to FIGS. 10-11, the base 112 of support 100 will be discussed. As shown in these figures, base 112 may define first and second chambers 146, 156. First and second chambers 146,156 may be separated from one another, or stacked on top of one another as shown. In other examples, a single chamber is used to accommodate multiple elements. First chamber 146 may be sized to accept a weighted element 148, such as a rectangular lead weight. Second chamber 156 may be sized to accept one or more second magnets 158 (e.g., two 30 mm D×3 mm H neodymium magnets). In this example, the second magnets 158 are disposed lower than the weighted element 148 so that base 112 of support 100 is magnetized to couple to a magnetic element in the environment (e.g., a magnetic desk mat). The second magnet(s) 158 and lead weight 148 may be secured within base 112 with a plastic end cap 160 that closes or seals off the chambers 146,156.

FIGS. 12-14 illustrate details of charging puck 200. Charging puck 200 may include a disk-shaped or circular body 202 having a first circular recess 206 for receiving a charger, such as an APPLE® MAGSAFE® charger. In some examples, body 202 may be formed of metal, a plastic, wood or other suitable materials. In some examples, body 202 may be formed of a same material as base 112 or arm 114. In some examples, body 202 may be formed of a different material than base 112 and/or arm 114. Optionally, body 202 may include an upper aperture 203 defined from the front to the back end, and shaped to allow a tool to decouple the body 202 from an inserted charger. Body 202 may include a lower aperture 205 that allows for routing of a wire from a charger.

Turning to FIGS. 13-14, located behind recess 205 is a chamber 216 size and shaped to receive a number of elements including, in order from the front to the back, a high permeability magnetic shield 220 (e.g., 19 gauge A3 Tool Steel), a plastic spacer 222 with an integrated circular magnet housing 223, a third magnet 224 (e.g., a 30 mm D×3 mm H neodymium magnet), and a plastic cover 226 to conceal the magnet. In a first mode, charging puck 200 may be used in combination with support 100 as shown in FIG. 1-7. In this example, third magnet 224 of charging puck 200 will be attracted to first magnet 118 of support 100. In some examples, the outer perimeter of body 202 of charging puck 200 will be disposed within primary recess 116 defined in arm 114 of support 100. Alternatively, in a second mode of operation, charging puck 200 may be used by itself by placing it flat on a surface such as a table or mat. In that example, third magnet 224 of charging puck 200 will be attracted to a magnetic element in the environment (e.g., a magnetic desk mat). Thus, third magnet 224 will serve the dual purpose of mating charging puck 200 to either support 100 or to a magnetic mat. Additionally, high permeability magnetic shield 220 may be used to screen the charger (e.g., the MAGSAFE® charger) from the effects of the third magnet 224. Without this layer, the magnetic field of third magnet 224 may interfere with the inductive charging which results in very low or often no power delivery to a mobile phone.

In some examples, charger stand 10 will be used with a multi-layer magnetized desk mat 300 such as that shown in FIG. 15. In this example, mat 300 includes three layers: a first layer 302 (e.g., a 2 mm layer of furniture linoleum or similar material), an intermediate magnetic element 304 (e.g., a rectangular steel sheet, 26-38 ga) and a third layer 306 (e.g., a 3 mm layer of merino wool). In some examples, the first and third layers 302,306 are made of the same material. In other examples, the first and third layers 302,306 are made of different materials. In some examples, at least one of the first and third layers 302,306 includes a relatively soft cloth or wool material. The three layers 302,304,306 may be coupled or adhered together using adhesive, fasteners, or other suitable means to form a magnetized desk mat 300.

It will be understood that the desk mat may be used on either side depending on the user's wishes. For example, the user may wish to have their hands resting on the wool material of layer 306, or on a linoleum layer 302, or they may choose to flip the mat some of the time. Regardless of the orientation or the layers of desk mat 300, it will be magnetic and capable of securing magnetic items or accessories including support 100 and/or charging puck 200.

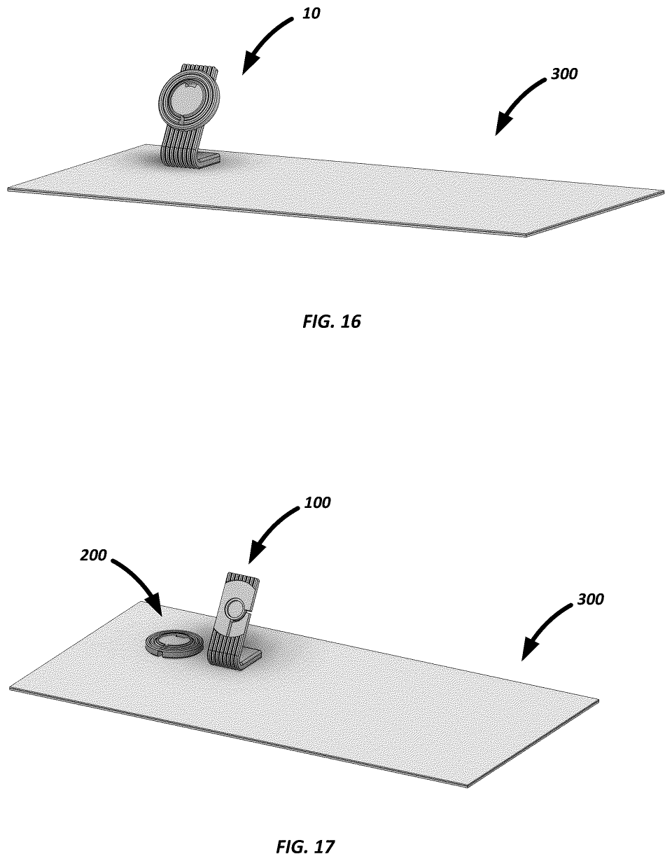

As shown in FIG. 16, charger stand 10 is being used in a first mode, where it is disposed on magnetized desk mat 300 and coupled thereto via magnets in the base so that the charger stand 10 is secured in position and does not tip when a phone is placed on puck 200. Here, the charging puck 200 is magnetically coupled to support 100. Alternatively, the charging puck 200 may be used separately from support 100 in a second mode, and both items, with their respective magnetic elements, may be coupled to desk mat 300 as shown in FIG. 17. It will be understood that other magnetic elements may be coupled to the desk mat as desired.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A charger stand comprising:
a support having a base and an inclined arm, the support having a first magnet on the inclined arm, and at least one second magnet disposed in the base; and
a charging puck coupleable to the support, the charging puck having a body defining a recess for accepting a magnetic charger, and a third magnet disposed behind the recess within the body.

2. The charger stand of claim 1, wherein the base and the inclined arm of the support are integrally formed.

3. The charger stand of claim 2, wherein the base and the inclined arm of the support are made of a non-magnetic material.

4. The charger stand of claim 1, wherein the inclined arm defines an oversized primary recess sized to accept the charging puck.

5. The charger stand of claim 4, wherein the inclined arm further defines a secondary recess disposed within the primary recess.

6. The charger stand of claim 5, wherein the inclined arm further defines a tertiary recess disposed within the secondary recess.

7. The charger stand of claim 6, wherein the tertiary recess is sized to accept the first magnet, and further comprising a plastic cover disposed within the secondary recess to hide the first magnet.

8. The charger stand of claim 1, wherein the base of the support includes a first chamber and a second chamber.

9. The charger stand of claim 8, further comprising a weighted element disposed within the first chamber, and wherein the at least one second magnet is disposed within the second chamber.

10. The charger stand of claim 1, wherein the charging puck defines a third chamber disposed behind, and being separate from the recess.

11. The charger stand of claim 10, wherein the third chamber is sized to receive the third magnet.

12. The charger stand of claim 11, further comprising a high permeability magnetic shield disposed between the third magnet and the recess.

13. The charger stand of claim 12, further comprising a plastic spacer with an integrated magnet housing disposed within the third chamber.

14. The charger stand of claim 13, further comprising a plastic cover sized to conceal the third magnet.

15. A system comprising:
the charger stand of claim 1; and
a desk mat having three layers including a first layer, an intermediate layer, and a third layer, the intermediate layer being magnetic.

16. The system of claim 15, wherein the intermediate layer comprises a metallic sheet.

17. The system of claim 15, wherein the intermediate layer comprises galvanized steel.

18. The system of claim 15, wherein the first layer comprises linoleum.

19. The system of claim 15, wherein the third layer comprises wool.

20. The system of claim 15, wherein the base of the support and the charging puck are magnetically attractable to the intermediate layer through either the first layer and the third layer.
